(19) United States
(12) Patent Application Publication
(10) Pub. No.: US 2010/0214663 A1
(43) Pub. Date: Aug. 26, 2010

(54) METHOD FOR MOLDING OPTICAL MEMBER, APPARATUS FOR MOLDING OPTICAL MEMBER AND OPTICAL MEMBER

(75) Inventors: Masato Yoshioka, Ashigarakami-gun (JP); Noriko Eiha, Ashigarakami-gun (JP); Seiichi Watanabe, Ashigarakami-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/675,202

(22) PCT Filed: Aug. 29, 2008
(86) PCT No.: PCT/JP2008/066015

§ 371 Date: Feb. 25, 2010

(30) Foreign Application Priority Data
Aug. 31, 2007 (JP) 2007-225837
Mar. 26, 2008 (JP) 2008-082220

(51) Int. Cl. G02B 3/00; B29D 11/00

(52) U.S. Cl. 359/642; 264/1.1; 425/470

(57) ABSTRACT

A method for molding an optical member from a material of a nanocomposite resin which includes a thermoplastic resin containing inorganic fine particles is provided. The method includes: charging a solution containing a solvent and the nanocomposite resin into a vessel providing at least an optical surface shape and an opening to an atmosphere, and evaporating the solvent from the opening to solidify and form an optical surface of the optical member into a finished shape.

### TECHNICAL FIELD

The present invention relates to an optical member molding method, an optical member molding apparatus and an optical member. More specifically, the present invention relates to an optical member molding method and an optical member molding apparatus, where an optical member with excellent optical characteristics can be formed using a nanocomposite resin, and an optical member.

### BACKGROUND ART

With recent progress of high-performance, compact and low-cost portable cameras and optical information recording devices such as DVD, CD or MO drive, development of excellent materials and processes is strongly demanded also for optical members such as optical lens and filter used in these recording devices.

A plastic lens is lightweight and hardly broken as compared with an inorganic material such as glass, can be processed into various shapes and has an advantage over a glass-made lens in view of cost and therefore, its usage is rapidly spreading not only as a spectacle lens but also as the above-described optical lens. This involves reduction in the size and thickness of the lens and for achieving such reduction, it is required, for example, to increase the refractive index of the material itself or stabilize the optical refractive index against thermal expansion or temperature change. As one of countermeasures therefor, various attempts are being made to form a nanocomposite resin by uniformly dispersing inorganic fine particles such as metal oxide fine particles in a plastic lens and thereby enhance the optical refractive index or suppress the temperature-dependent change in the thermal expansion coefficient or optical refractive index (see, for example, JP-A-2006-343387 and JP-A-2003-147090).

In the case of molding an optical member by using such a nanocomposite resin and when high transparency is required of the optical member, for reducing light scattering, the inorganic fine particles need to be dispersed to create a state of the particle diameter of the inorganic fine particles being smaller than at least the wavelength of light used. Furthermore, nanoparticles uniformly having a particle size of 15 nm or less should be prepared and dispersed so as to restrain the transmitted light intensity from attenuating due to Rayleigh scattering. Also, for effectively increasing the optical refractive index, it is required to uniformly disperse the inorganic fine particles.

The technique for producing a nanocomposite material by dispersing inorganic fine particles in plastic resin includes the following methods:

(1) where inorganic fine particles are directly charged into plastic resin and blended,

(2) where inorganic fine particles are mixed in a liquid working out to a solvent and the solvent is then removed by heat or the like, and

(3) where monomer and inorganic fine particles are mixed and the monomer is then polymerized to contain the inorganic fine particles.

The thus-produced nanocomposite resin may be molded into an optical member having a desired shape, for example, by (1) a method using injection molding, (2) a method of causing great plastic deformation of a bulk, or (3) a method of casting a fluidized resin into a mold and transferring the shape (cast molding method). In the method (1), the nanocomposite resin exhibits bad flowability even at a high temperature and not only injection molding is difficult but also fine particles are locally aggregated, failing in obtaining a transparent optical member with a constant dispersion density. Also, since high quality is required of the optical member, the material remaining in the runner at injection molding is not reused but discarded due to quality deterioration, and this leads to an about 90% loss of the material based on the entire charged amount and a rise in the cost of a high value-added material such as nanocomposite resin. In the method (2), distortion remains and affects the optical characteristics. In the method (3), the nanocomposite resin is, even when heated, not fluidized to an extent allowing for satisfactory transfer and the resin is formed into a solution state by adding a solvent and then cast, but in this case, since the gate portion of a conventional mold is made long so that reduction in the volume occurring with removal of the solvent can be prevented from reaching the product part, the diffusion length becomes large and it takes a long time to achieve a residual solvent amount not causing a change in the shape. In order to solve this problem, for example, JP-A-5-90645 describes a method where cast molding is performed in twice for one surface and then another surface of a product to shorten the diffusion length. However, this method is disadvantageous in that, for example, light is reflected on an interface generated inside of the optical member and optical axis displacement readily occurs.

### DISCLOSURE OF THE INVENTION

An object of the present invention is to provide an optical member molding method and an optical member molding apparatus, where an optical member with stable optical characteristics can be formed from a solution of a nanocomposite resin containing an inorganic fine particle in a thermoplastic resin, and an optical member.

The above object of the present invention can be achieved by the following optical member molding method.

(1) An optical member molding method for molding a light-transparent optical member from a material of a nanocomposite resin which includes a thermoplastic resin containing inorganic fine particles, the optical member molding method comprising the steps of: a solution charging step of charging a solution containing a solvent and the nanocomposite resin into a vessel providing at least an optical surface shape and an opening to an atmosphere; and an optical member forming step of evaporating the solvent from the opening to solidify and form an optical surface of the light-transparent optical member into a finished shape.

According to the optical member molding method above, the solution having uniformly dispersed therein a nanocomposite resin is solidified as-is in a uniformly dispersed state to form an optical member, so that an optical member can be molded from a nanocomposite resin which has been heretofore difficult to mold.

Also, an optical member is formed from a solution having uniformly dispersed therein a nanocomposite resin, so that there can be molded an optical member having a high refractive index and excellent optical properties obtained by uniformly dispersing inorganic fine particles such as metal oxide fine particles in the plastic resin.

(2) The optical member molding method as described in (1) above, wherein in the solution charging step, the solution is charged in a state allowing the optical surface shape to comprise a first optical surface shape of the inner bottom of the vessel and a second optical surface shape located at a desired distance in the solution from the first optical surface shape.

According to the optical member molding method above, in the solution charging step, the solution is charged in a state allowing the optical surface shape to comprise a first optical surface shape of the inner bottom of the vessel and a second optical surface shape located at a desired distance in the solution from the first optical surface shape, so that an optical member having two optical surface planes (first optical surface shape and second optical surface shape) can be molded by one molding step. Consequently, a high-precision optical member can be easily molded in a short time as compared with the case of forming one optical member by laminating a pair of optical members each having an optical shape plane formed on one surface.

(3) The optical member molding method as described in (1) above, wherein after charging the solution in the solution charging step, a second optical surface shape-forming member is inserted into the solution located at a desired distance from the first optical surface shape on a bottom of the vessel before the nanocomposite resin becomes a solid state capable of maintaining an approximate optical surface shape.

According to the optical member molding method above, the insertion of an optical surface shape member having a second optical surface shape is waited until the nano-composite resin becomes a solid state resulting from evaporation of the solvent in the solution charged into the vessel, so that the surface of the opening to the atmosphere can take a large opening area, the diffusion length can be greatly shortened and the drying time can be reduced.

(4) The optical member molding method as described in any one of (1) to (3) above, wherein in the solution charging step, the solution is measured so as to contain the nanocomposite resin in an amount large enough to mold the optical member and then charged.

According to the optical member molding method above, the solution is charged into the vessel providing at least an optical application shape transfer surface and an opening to an atmosphere after being measured to contain a nanocomposite resin in an amount large enough to mold the optical member, so that an optical member can be unfailingly molded by evaporating the solvent in the solution.

(5) The optical member molding method as described in any one of (1) to (4) above, wherein in the optical member forming step, a relationship of the boiling point Tb (° C.) of the solvent in the nanocomposite resin solution the solvent temperature T (° C.) at evaporation is satisfied under an atmospheric pressure.

According to the optical member molding method above, the drying temperature T (° C.) satisfies Tb≧T under atmospheric pressure with respect to the boiling point Tb (° C.) of the solvent in the nanocomposite resin solution, so that there can be avoided a state where when the drying temperature exceeds Tb, bubbles are generated in the molded product and the desired shape is not obtained. Here, Tb-30≧T is preferred, and bubbles are scarcely generated at about Tb-30° C. Furthermore, Tb-50≧T is more preferred, and bubbles are not generated at all at Tb-50° C.

(6) The optical member molding method as described in any one of (1) to (4) above, wherein in the solution charging step, the solution is charged under a reduced pressure.

According to the optical member molding method above, the solution is charged under a reduced pressure, so that the solution can be fully spread in the vessel whatever shape the mold has.

Also, the above object of the present invention can be achieved by the following optical member molding apparatus.

(7) An optical member molding apparatus for molding a light-transparent optical member from a material of a nanocomposite resin which includes a thermoplastic resin containing inorganic fine particles, the optical member molding apparatus comprising: a vessel-like lower mold having on a bottom thereof a first optical surface shape for forming one optical surface of the optical member and providing an opening to an atmosphere; and an upper mold including an optical surface shape-forming member having a second optical surface shape for forming another optical surface of the optical member, the upper mold being disposed to locate at a desired distance from the first optical surface shape.

According to the optical member molding apparatus having the above-described construction, the apparatus comprises a vessel-like lower mold carrying a first optical surface shape for forming one optical surface of the optical member and providing an opening to an atmosphere and an upper mold including an optical surface shape-forming member having a second optical surface shape for forming another optical surface, so that by disposing the first optical surface shape and the second optical surface shape to locate at a desired distance and evaporating a solvent after charging a nanocomposite resin-containing solution into the vessel-like lower mold, an optical member having formed on both surfaces thereof an approximate optical surface shape can be easily molded.

(8) The optical member molding apparatus as described in (7) above, wherein at least one of the first optical surface shape and the second optical surface shape is made of glass.

(9) The optical member molding apparatus as described in (7) or (8) above, wherein at least one of the first optical surface shape and the second optical surface shape is formed by a glass mold method.

In the industrial production of a lens, it is considered to array many vessels and increase the number of lenses produced per hour, but if the first and second optical surface shapes are mass-produced using a metal or the like, the cost rises due to optical polishing and the like. Therefore, in such a case, low-cost production of the optical surface shape is required. According to the optical member molding apparatus having the above-described construction, the optical surface shape is formed by a glass mold method, so that the molding apparatus can be produced in a large amount at a low cost.

Also, the above-described object can be achieved by the following optical member.

(10) An optical member formed by the optical member molding method described in any one of (1) to (6) above.

(11) The optical member as described in (10) above, wherein the optical member is a lens.

According to the optical member above, the optical member is a lens, so that a lens substrate having a high refractive index and excellent optical properties can be easily produced.

### Advantageous Effects

According to embodiments of the present invention, there can be provided an optical member molding method and an optical member molding apparatus, where an optical member with stable optical characteristics can be molded from a solution of a nanocomposite resin containing an inorganic fine particle in a thermoplastic resin, and an optical member.

### BRIEF DESCRIPTION OF THE DRAWINGS

FIG. 1 is a longitudinal cross-sectional view showing a rough construction of an optical member molding apparatus according to an exemplary embodiment of the present invention;

FIG. 2 is an explanatory view schematically showing steps through which an optical member is molded from a nanocomposite resin-containing solution by the optical member molding apparatus shown in FIG. 1; and

FIG. 3 is a graph showing the change in the weight of the nanocomposite resin-containing solution with aging in the optical member molding process.

### BEST MODE FOR CARRYING OUT THE INVENTION

Exemplary embodiments of the method and apparatus for molding an optical member of the present invention are described in detail below by referring to the drawings.

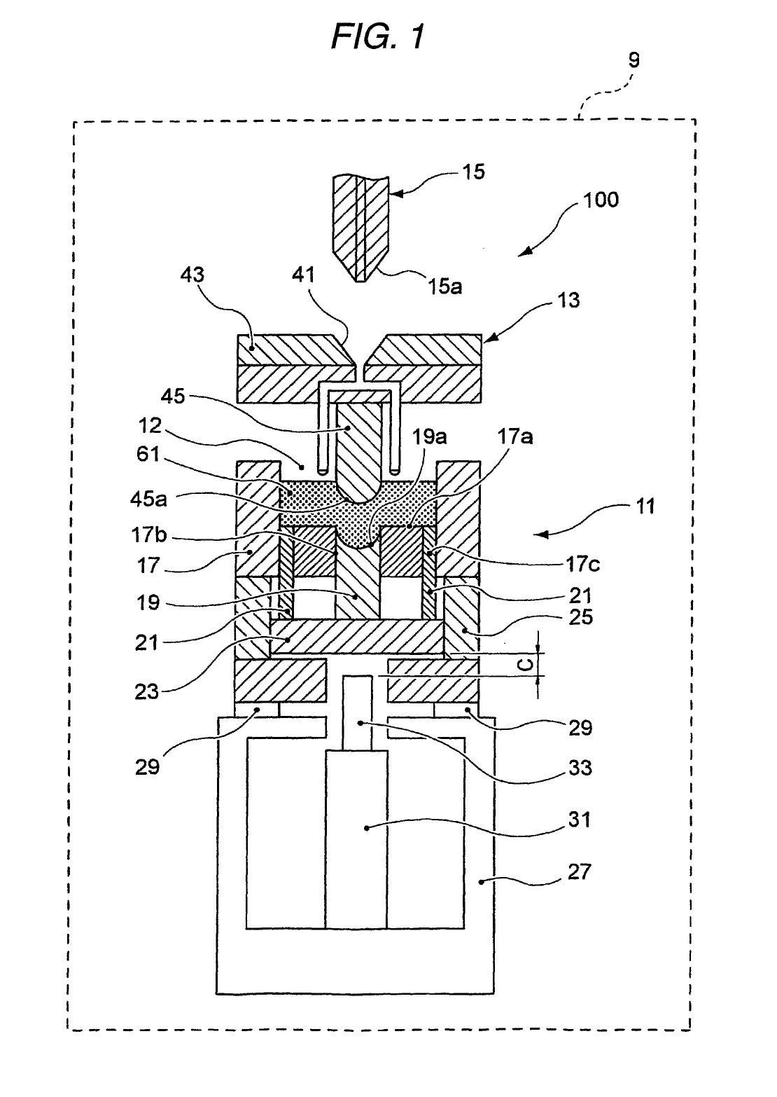

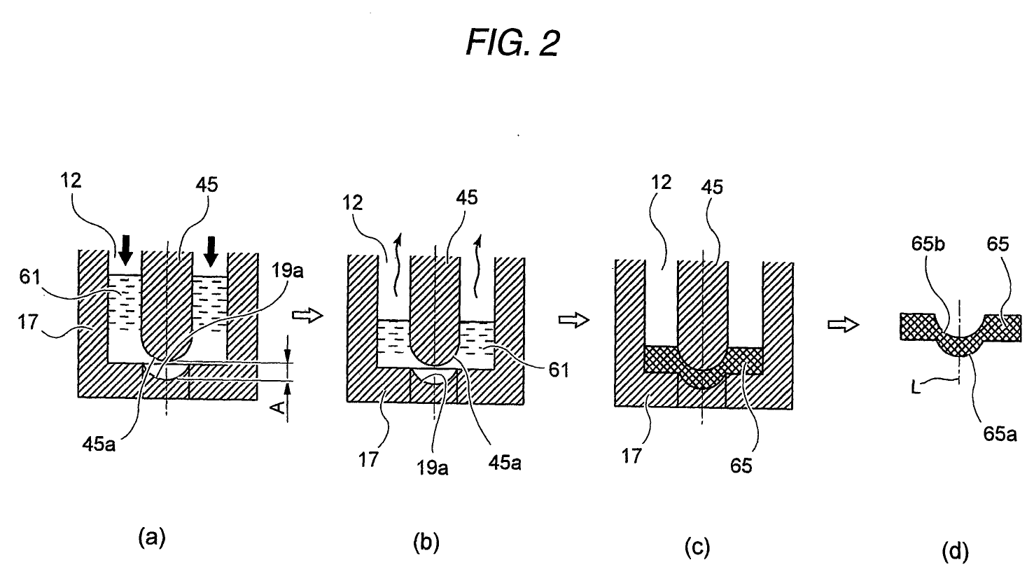

FIG. 1 is a longitudinal cross-sectional view showing a rough construction of an optical member molding apparatus according to an exemplary embodiment of the present invention, and FIG. 2 is an explanatory view schematically showing steps through which an optical member is molded from a nanocomposite resin-containing solution by the optical member molding apparatus shown in FIG. 1.

As shown in FIG. 1, the optical member molding apparatus 100 includes a vessel-like lower mold 11, a convex upper mold 13 and a dispenser device 15 and is arranged in a drying chamber 9. The vessel-like lower mold 11 includes an approximate cylindrical vessel 17 open to the outside at an open-to-atmosphere surface (an opening to an atmosphere) 12 provided on the top, a core 19 capable of slidably fitting into a core hole 17b provided in the center on the bottom 17a of the cylindrical vessel 17, and an ejector pin 21. Depending on the shape of the optical member, the shape of the convex upper mold 13 may be changed to a concave shape and also in this case, the present invention can be implemented. The bottom 17a outside of the core hole 17b comes to mold the flange part of the optical member.

In the core 19, a first optical surface shape 19a taking a semispherical concave plane form is formed on the top. The first optical surface shape 19a transfers its shape to a light-transparent optical member 65 described later to form one optical surface shape plane (convex plane) 65a (see, FIG. 2(d)). Depending on the shape of the optical member, the shape of the first optical surface shape 19a may be changed to a convex shape and also in this case, the present invention can be implemented.

The ejector pin 21 is, in FIG. 1, fixed to a movable plate 23 allowed vertical movement and slidably fits into a pin hole 17c provided on the bottom 17a of the cylindrical vessel 17. The core 19 is fixed to the top of the movable plate 23 and vertically moves together with the ejector pin 21 as the movable plate 23 moves.

The cylindrical vessel 17 is placed on a weight sensor 29 disposed on the top of a base 27 through a spacer 25. The weight sensor 29 is, for example, a load cell capable of precisely detecting the loaded weight as a strain of a sensor element and measures the weight of the vessel-like lower mold 11 (including the spacer 25) and a nanocomposite resin-containing solution 61 charged into the vessel-like lower mold 11.

Below the movable plate 23, a cylinder 31 is provided in the base 27 by arranging a piston 33 to face the movable plate 23. When the piston 33 is withdrawn into the cylinder 31, a gap C is created between the piston 33 and the movable plate 23 to avoid contact of the piston with the removable plate. This enables the weight sensor 29 to measure the weight of the vessel-like lower mold 11 and the solution 61.

The convex upper mold 13 includes a plate-like member 43 where a solution charging hole 41 is formed, and an approximate columnar upper mold 45 which is a second optical surface shape-forming member fixed on the bottom of the plate-like member 43 to protrude downward. The convex upper mold 13 is vertically movable with respect to the vessel-like lower mold 11. A second optical surface shape 45a taking a semispherical convex plane form is provided on the bottom of the upper mold 45. The second optical surface shape 45a transfers its shape to the light-transparent optical member 65 to form another optical shape plane (concave plane) 65b. The axial center of the core 19 is arranged to agree with the axial center of the upper mold 45.

The materials used for the vessel-like lower mold 11 (the cylindrical vessel 17, the core 19 and the ejector pin 21) and the convex upper mold 13 (upper mold 45) are not particularly limited as long as it is material workable to have the required surface roughness (at least the first optical surface shape 19a and the second optical surface shape 45a are preferably worked to bear a mirror surface), and for example, a metal material such as stainless steel and Stavax, a ceramic, a glass, and a resin material such as Teflon (registered trademark) can be used.

The dispenser device 15 has a tip 15a formed like a nozzle and is connected through a tube or the like to a solution tank (not shown) reserving the nanocomposite resin-containing solution 61. The solution tank contains a concentration-controlled solution and the volume is weighed by the dispenser device 15, whereby a nanocomposite resin in a desired amount can be fed to the vessel-like lower mold 11. The tip 15a is freely movable to the direction approaching to or receding from the plate-like member 43 and by abutting the tip 15a on the solution charging hole 41 of the plate-like member 43, the nanocomposite resin-containing solution 61 is fed to the vessel-like lower mold 11.

The constitutional requirements described below are based on an exemplary embodiment of the present invention, but the present invention is not limited to such an embodiment. Incidentally, the numerical range denoted by using “(a numerical value) to (a numerical value)” means a range including the numerical values before and after “to” as the lower limit and the upper limit, respectively.

The operation of this embodiment is described. As shown in FIGS. 1 and 2, the piston 33 of the cylinder 31 is moved downward to keep the piston 33 away from the movable plate 23 and then, the weight of the empty vessel-like lower mold 11 (including the spacer 25) is measured by the weight sensor 29. Subsequently, the tip 15a of the dispenser device 15 is abutted on the solution charging hole 41 of the plate-like member 43 and after the nanocomposite resin-containing solution 61 of a weight previously determined according to the optical member 65 molded is fed to the vessel-like lower mold 11, the weight is again measured by the weight sensor 29 to confirm that the solution 61 of a weight is fed (solution charging step).

At this time, the nanocomposite resin-containing solution 61 is preferably prevented from intruding into the clearance between the ejector pin 17c and the bottom 17a, and to this end, the concentration of the solution needs to be set to 5 wt % or more. Furthermore, in view of easiness of handling and the time necessary for drying, the concentration is preferably from 10 to 60 wt %. The concentration is more preferably from 20 to 50 wt % and this is advantageous in view of production.

In the optical member forming step, the upper mold 45 is moved downward to dip its tip (second optical surface shape 45a) in the solution 61 and fixed after arranging the first optical surface shape 19a of the core 19 and the second optical surface shape 45a of the upper mold 45 at a distance A and locating these shapes at desired positions. Here, the distance A is determined by the thickness of the optical member 65 molded and is set by taking into consideration the volume decrease or shrinkage due to evaporation of the solution, and the desired positions are the same as the relative positions of the optical shape planes 65a and 65b of the optical member 65 and are disposed to face each other with respect to the optical axis L of the optical member 65 (see, FIG. 2(d)).

Furthermore, in the optical member-forming step, as shown in FIGS. 2(b) and (c), the inside of the drying chamber 9 in which the optical member forming apparatus 100 is disposed is set to an environment where the concentration of the nanocomposite resin charged is adjusted to 36 wt % by using methyl ethyl ketone as the solvent and where the distance A is 1 mm, the upper mold diameter is 8 mm, the inner diameter of the cylindrical vessel is 10 mm, the distance between the bottom 17a and the liquid level is 2.8 mm, the temperature is 30° C. and the pressure is the atmospheric pressure, and this environment is left standing for 100 hours to allow the progress of drying, as a result, the solvent in the solution 61 evaporates from the open-to-atmosphere surface 12 of the solution 61 in the cylindrical vessel 17 and the solidification gradually proceeds. Eventually, a light-transparent optical member 65 in a solid state capable of maintaining the optical surface shape is obtained. That is, the first optical surface shape 19a of the core 19 and the second optical surface shape 45a of the upper mold 45 are transferred as the optical shape planes 65a and 65b of the light-transparent optical member 65.

At this time, the temperature T (° C.) at the drying preferably satisfies Tb≧T under the atmospheric pressure with respect to the boiling point Tb (° C.) of the solvent in the nanocomposite resin solution. By satisfying such a condition, there can be avoided a state where the drying temperature T exceeds Tb, bubbles are generated in the molded product and the desired shape is not obtained. The condition above is preferably Tb-30≧T, and bubbles are scarcely generated at about Tb-30° C. The condition is more preferably Tb-50≧T, and bubbles are not generated at all at Tb-50° C.

The solidified state, that is, whether solidification proceeded to a state capable of maintaining the optical surface shape, can be easily judged, other than the observation with an eye or the examination by touch or the like, from the decreased weight obtained by measuring the current weight by the weight sensor 29 and subtracting it from the weight before the solution starts evaporating.

Finally, the cylinder 31 is actuated and after the core 19 and the ejector pin 21 are pushed up by the piston 33 through the movable plate 23, as shown in FIG. 2(d), the optical member is taken out from the cylindrical vessel 17.

If desired, the optical member 65 taken out may be left standing in the drying chamber 9 kept at a temperature of 40° C. and a vacuum degree of 10⁻¹ Pa to further evaporate the solvent and achieve complete drying.

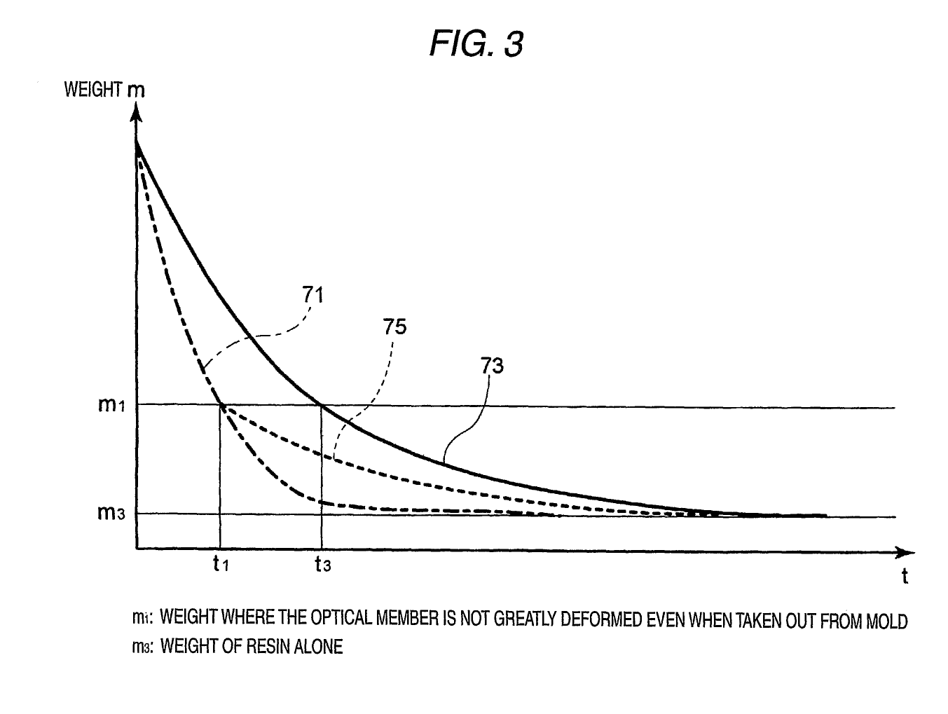

FIG. 3 is a graph showing the change in the weight of the nanocomposite resin-containing solution with aging in the optical member molding process. In the description above, immediately after feeding the solution 61 to the vessel 17, the upper mold 45 is moved downward and dipped in the solution 61, where the evaporation/solidification proceeds according to the curve shown by a full line 73 of FIG. 3. However, the timing of feeding the solution 61 and moving the upper mold 45 downward is not limited thereto and after evaporating the solvent for a while in a state of the solution 61 being fed (the upper mold 45 being not moved downward), the upper mold 45 may be moved downward immediately before the solution 61 becomes semi-solid (m1 in FIG. 3). In this case, the solvent evaporates from an area (open-to-atmosphere surface) broadened by the area portion of the upper mold 45, and the weight decreases according to the curve shown by a one-dot chain line 71 in FIG. 3 until the time t1 where the weight becomes m1. After the upper mold 45 is moved downward, the weight decreases according to a dotted line 75, as a result, the evaporation time is shortened.

Also, in the embodiment above, the light-transparent optical member 65 is molded in the vessel 17 by using the first optical surface shape 19a carried on the core 19 and the second optical surface shape 45a carried on the upper mold 45, but in a most fundamental form of the lens, it is sufficient if only a first approximate optical surface shape 19a is formed, and a construction dispensing with the upper mold 45 may also be employed.

Furthermore, as another construction of the method regarding the upper mold 45, a construction of disposing the position of the upper mold 45 at a position in the vessel 17 before feeding the solution 61 to the vessel 17 and thereafter, performing the same processing steps may be also employed.

In this case, the surface exposed to the atmosphere at the drying becomes narrow and the solvent evaporation takes a slightly long time, but the solution is naturally charged and this enables the atmosphere to avoid being trapped and intruding into the solution. Accordingly, the latitude in the shape of the upper mold 45 increases as compared with the above-described embodiment where the upper mold 45 is moved and inserted into the solution.

Incidentally, the present invention is not limited to these embodiments, and modifications, improvements and the like can be appropriately made therein. Also, the optical member to which the present invention is applicable includes not only various lenses but also a light guide plate of liquid crystal displays and the like and an optical film such as polarizing film and retardation film.

For example, in place of the dispenser 15, the solution may be transferred by a solution sending system such as peristaltic pump.

Also, in the embodiment above, the amount of the solution charged by the dispenser 15 is adjusted by the weight, but the amount may be adjusted by the volume, bulk or the like. The solution feed nozzle is also not limited to two portions shown in FIG. 1.

Furthermore, the feed of the solution is not limited to from the top of the upper mold 13, but the solution may be fed, for example, from the interspace between the upper mold 13 and the lower mold 11, from the side surface of the cylindrical vessel 17, or from the bottom of the lower mold 11. Depending on the shape of the light-transparent optical member 65, a plurality of upper molds 13/lower molds 11 may be used.

In addition, in the case of industrially producing a lens, it is considered to array many vessels and increase the number of lenses produced per hour, but if the first and second optical surface shapes are mass-produced using a metal or the like, the cost rises due to optical polishing and the like. However, when the first optical surface shape portion and second optical surface shape portion of the upper mold 13 and lower mold 11 are made of glass, polishing can be dispensed with and the optical surface shape portion can be produced at a low cost. In this case, the optical surface shape can be produced by a glass mold method, which enables producing the molding apparatus in a large amount at a low cost.

In FIG. 1, the upper mold 13 is perpendicularly inserted from the above, but the angle is not limited to perpendicularity and may be in any direction. Similarly, the lower mold 11 may be directed in any direction. In FIG. 1, three ejectors 19 and 21 including the core 19 are employed, but the number of ejectors is not limited to three. Also, in FIG. 1, the weight is measured at two portions by the sensor 29, but the number of portions measured is not limited to two. Furthermore, the sensor is not limited to one kind and a plurality of kinds may be combined. The cylinder 31 may be any cylinder such as pneumatic, electric or hydraulic cylinder.

As for the drying atmosphere, other than the atmosphere of atmospheric pressure or reduced pressure, the drying may be performed in a gas atmosphere such as vacuum atmosphere, nitrogen atmosphere, carbon dioxide atmosphere, and rare gas atmosphere (e.g., argon). By charging the solution in vacuum, the solution can be satisfactorily spread in the vessel whatever shape the mold has.

In the best mode above, the method for heating the press mold is an induction heating system by a coil, but the heating system may be, for example, heat transfer by a heater or light heating by a halogen lamp or the like.

### (Nanocomposite Material (Resin))

The nanocomposite material (nanocomposite material where inorganic fine particles are bonded to a thermoplastic resin) working out to the material of the optical member of the present invention is described in detail below.

### (Inorganic Fine Particle)

For the organic-inorganic composite material used in an exemplary embodiment of the present invention, an inorganic fine particle having a number average particle size of 1 to 15 nm is used. If the number average particle size of the inorganic fine particle is too small, the properties inherent in the material constituting the fine particle may change, whereas if it is excessively large, the effect of Rayleigh scattering becomes conspicuous and the transparency of the organic-inorganic composite material may extremely decrease. Accordingly, the number average particle size of the inorganic fine particle for use in the present invention needs to be from 1 to 15 nm and is preferably from 2 to 13 nm, more preferably from 3 to 10 nm.

Examples of the inorganic fine particle for use in the present invention include an oxide fine particle, a sulfide fine particle, a selenide fine particle and a telluride fine particle. Specific examples thereof include a titania fine particle, a zinc oxide fine particle, a zirconia fine particle, a tin oxide fine particle and a zinc sulfide fine particle. Among these, a titania fine particle, a zirconia fine particle and a zinc sulfide fine particle are preferred, and a titania fine particle and a zirconia fine particle are more preferred, but the present invention is not limited thereto. In the present invention, one kind of an inorganic fine particle may be used or a plurality of kinds of inorganic fine particles may be used in combination.

The refractive index at a wavelength of 589 nm of the inorganic fine particle for use in the present invention is preferably from 1.70 to 3.00, more preferably from 1.70 to 2.70, still more preferably from 2.00 to 2.70. When an inorganic fine particle having a refractive index of 1.70 or more is used, an organic-inorganic composite material having a refractive index higher than 1.65 can be easily produced, and when an inorganic fine particle having a refractive index of 3.00 or less is used, production of an organic-inorganic composite material having a transmittance of 80% or more tends to be facilitated. The refractive index as used in the present invention is a value obtained at 25° C. by measuring light at a wavelength of 589 nm by an Abbe Refractometer (DR-M4, manufactured by Atago Co., Ltd.).

### (Thermoplastic Resin)

The thermoplastic resin for use in an exemplary embodiment of the present invention is not particularly limited in its structure, and examples thereof include resins having known structures, such as poly(meth)acrylic acid ester, polystyrene, polyamide, polyvinyl ether, polyvinyl ester, polyvinyl carbazole, polyolefin, polyester, polycarbonate, polyurethane, polythiourethane, polyimide, polyether, polythioether, polyether ketone, polysulfone and polyethersulfone. Above all, in the present invention, a thermoplastic resin having, at the polymer chain terminal or in the side chain, a functional group capable of forming an arbitrary chemical bond with the inorganic fine particle is preferably used. Preferred examples of such a thermoplastic resin include:

(1) a thermoplastic resin having a functional group selected from the followings at the polymer chain terminal or in the side chain:

### Formulae:

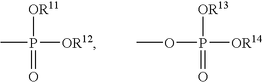

(wherein R¹¹, R¹², R¹³ and R¹⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H and —Si(OR¹⁵)ₘ₁R¹⁶₃₋ₘ₁ (wherein R¹⁵ and R¹⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m1 represents an integer of 1 to 3); and

(2) a block copolymer composed of a hydrophobic segment and a hydrophilic segment.

The thermoplastic resin (1) is described in detail below.

### Thermoplastic Resin (1):

The thermoplastic resin (1) for use in the present invention has, at the polymer chain terminal or in the side chain, a functional group capable of forming a chemical bond with the inorganic fine particle. The “chemical bond” as used herein includes, for example, a covalent bond, an ionic bond, a coordination bond and a hydrogen bond, and in the case where a plurality of functional groups are present, these functional groups each may form a different chemical bond with the inorganic fine particle. Whether or not a chemical bond can be formed is judged by whether or not the functional group of the thermoplastic resin can form a chemical bond with the inorganic fine particle when the thermoplastic resin and the inorganic fine particle are mixed in an organic solvent. The functional groups of the thermoplastic resin all may form a chemical bond with the inorganic fine particle, or a part thereof may form a chemical bond with the inorganic fine particle.

The thermoplastic resin for use in the present invention is preferably a copolymer having a repeating unit represented by the following formula (1). Such a copolymer can be obtained by copolymerizing a vinyl monomer represented by the following formula (2).

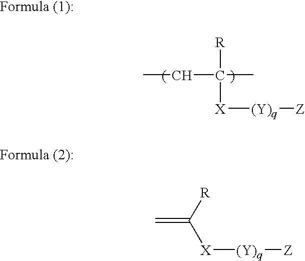

In formulae (1) and (2), R represents a hydrogen atom, a halogen atom or a methyl group, and X represents a divalent linking group selected from the group consisting of —CO₂—, —OCO—, —CONH—, —OCONH—, —OCOO—, —O—, —S—, —NH— and a substituted or unsubstituted arylene group and is preferably —CO₂— or a p-phenylene group.

Y represents a divalent linking group having a carbon number of 1 to 30, and the carbon number is preferably from 1 to 20, more preferably from 2 to 10, still more preferably from 2 to 5. Specific examples thereof include an alkylene group, an alkyleneoxy group, an alkyleneoxycarbonyl group, an arylene group, an aryleneoxy group, an aryleneoxycarbonyl group, and a group comprising a combination thereof. Among these, an alkylene group is preferred.

q represents an integer of 0 to 18 and is preferably an integer of 0 to 10, more preferably an integer of 0 to 5, still more preferably an integer of 0 to 1.

Z is a functional group shown in the “Formulae” above.

Specific examples of the monomer represented by formula (2) are set forth below, but the monomer which can be used in the present invention is not limited thereto.

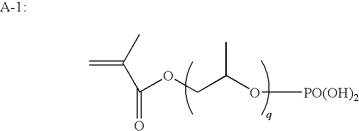

A mixture of q=5 and 6.

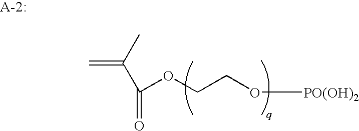

A mixture of q=4 and 5.

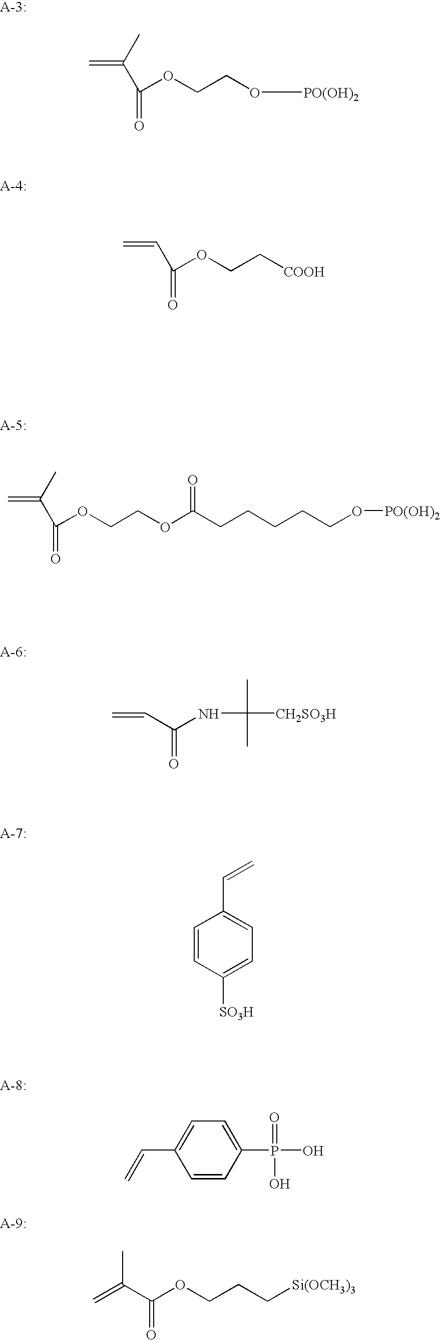

In the present invention, as for other kinds of monomers copolymerizable with the monomer represented by formula (2), those described in J. Brandrup, Polymer Handbook, 2nd ed., Chapter 2, pp. 1-483, Wiley Interscience (1975) may be used.

Specific examples thereof include a compound having one addition-polymerizable unsaturated bond, selected from styrene derivatives, 1-vinylnaphthalene, 2-vinylnaphthalene, vinylcarbazole, acrylic acid, methacrylic acid, acrylic acid esters, methacrylic acid esters, acrylamides, methacrylamides, allyl compounds, vinyl ethers, vinyl esters, dialkyl itaconates, and dialkyl esters or monoalkyl esters of fumaric acid above.

The weight average molecular weight of the thermoplastic resin (1) for use in the present invention is preferably from 1,000 to 500,000, more preferably from 3,000 to 300,000, still more preferably from 10,000 to 100,000. When the weight average molecular weight of the thermoplastic resin (1) is 500,000 or less, the molding processability tends to be enhanced, and when it is 1,000 or more, the dynamic strength tends to be enhanced.

In the thermoplastic resin (1) for use in the present invention, the number of functional groups bonded to the inorganic fine particle is preferably, on average, from 0.1 to 20, more preferably from 0.5 to 10, still more preferably from 1 to 5, per one polymer chain. When the number of the functional groups is 20 or less on average per one polymer chain, the thermoplastic resin (1) tends to be prevented from coordination to a plurality of inorganic fine particles, which raises the viscosity in the solution state or causes gelling, and when the average number of functional groups is 0.1 or more per one polymer chain, this tends to yield stable dispersion of inorganic fine particles.

The glass transition temperature of the thermoplastic resin (1) for use in the present invention is preferably from 80 to 400° C., more preferably from 130 to 380° C. When a resin having a glass transition temperature of 80° C. or more is used, an optical component having sufficiently high heat resistance can be easily obtained, and when a resin having a glass transition temperature of 400° C. or less is used, the mold processing tends to be facilitated.

As described above, in the nanocomposite material as a material for the optical member of the invention, the resin contains a unit structure having a specific structure, so that the releasability from a molding mold can be enhanced without impairing the high refractivity and high transparency of the organic-inorganic composite material in which inorganic fine particles are dispersed.

According to this material, an organic-inorganic composite material having all of excellent releasability, high refractivity and high transparency, and an optical member containing the composite material, which is assured of all of high precision, high transparency and high refractivity, can be provided.

The present application claims foreign priority based on Japanese Patent Application Nos. JP2007-225837 and JP2008-082220, filed Aug. 31, 2007 and Mar. 26, 2008, respectively, the contents of which are incorporated herein by reference.

1. A method for molding an optical member from a material of a nanocomposite resin which includes a thermoplastic resin containing inorganic fine particles,
the method comprising:
charging a solution containing a solvent and the nanocomposite resin into a vessel providing at least an optical surface shape and an opening to an atmosphere, and
evaporating the solvent from the opening to solidify and form an optical surface of the optical member into a finished shape.

2. The method according to claim 1, wherein the solution is charged in a state allowing the optical surface shape to comprise a first optical surface shape of an inner bottom of the vessel and a second optical surface shape located at a distance in the solution from the first optical surface shape.

3. The molding method according to claim 1, further comprising, after charging the solution, inserting a member for forming a second optical surface shape into the solution so located at a distance from the first optical surface shape on a bottom of the vessel before the nanocomposite resin becomes a solid state capable of maintaining an approximate optical surface shape.

4. The method according to claim 1, further comprising, before charging the solution, measuring an amount of the nanocomposite resin to be large enough to mold the optical member.

5. The method according to claim 1, wherein in the evaporating the solution, a boiling point Tb ° C. of the solvent in the solution and an evaporation temperature T ° C. of the solvent satisfies: Tb≧T under an atmospheric pressure.

6. The method according to claim 1, wherein the solution is charged under a reduced pressure.

7. An apparatus for molding an optical member from a material of a nanocomposite resin which includes a thermoplastic resin containing inorganic fine particles, the apparatus comprising:
a vessel-like lower mold having on a bottom thereof a first optical surface shape for forming one optical surface of the optical member and providing an opening to an atmosphere, and
an upper mold including an optical surface-forming member having a second optical surface shape for forming another optical surface of the optical member, the upper mold being disposed at a distance from the first optical surface shape.

8. The apparatus according to claim 7, wherein at least one of the first optical surface shape and the second optical surface shape is made of glass.

9. The apparatus according to claim 7, wherein at least one of the first optical surface shape and the second optical surface shape is formed by a glass mold method.

10. An optical member formed by a method according to claim 1.

11. The optical member according to claim 10, which is a lens.
